(19) United States
(12) Patent Application Publication
(10) Pub. No.: US 2013/0113179 A1
(43) Pub. Date: May 9, 2013

(54) Wheelchair Stabiliser

(71) Applicant: Andrew Laurence O'Sullivan, Auckland (NZ)

(72) Inventor: Andrew Laurence O'Sullivan, Auckland (NZ)

(21) Appl. No.: 13/697,436

(22) PCT Filed: May 11, 2011
(86) PCT No.: PCT/NZ2011/000073

§ 371 Date: Jan. 25, 2013

(30) Foreign Application Priority Data
May 11, 2010 (NZ) 585287

(51) Int. Cl. B62B 5/00

(52) U.S. Cl. CPC B62B 5/00
USPC 280/293

(57) ABSTRACT

A stabilised wheelchair configured for a user suffering lower extremity weight loss comprising: a frame that supports a seat and which is moveable over the ground surface by a set of manually operable rear propulsion wheels and one or more forward steering wheels. The stabiliser assembly comprises a weight device that is releasably secured to the frame of the wheelchair by a mounting assembly at a position forward of the rotation axis of the rear propulsion wheels of the wheelchair and which has a weight that is sufficient to counterbalance the user's lower extremity weight loss to maintain fore-aft stability of the wheelchair in use.

### FIELD OF THE INVENTION

The present invention relates to wheelchairs. In particular, although not exclusively, the invention relates to manually operated wheelchairs.

### BACKGROUND TO THE INVENTION

Wheelchairs are used by people with various physical conditions, including amputees. People suffering from a lower-limb amputation often have difficulty using conventional manually operated wheelchairs due to instability caused by the loss of weight of the absent limb. For example, lower-limb amputees can often tip backward over the rear wheels of a conventional wheelchair when accelerating from rest.

To address the above problem, specially designed amputee wheelchairs have been proposed in which the axis of rotation of the rear wheel is moved backward behind the center of mass of the user to reduce the effects from the loss of weight of the amputated limb. While this modified design addresses the instability associated with the use of conventional wheelchairs by amputees, it causes new problems in itself. As is well known, the user moves the wheelchair by exerting hand pressure onto annular rails attached to the rear propulsion wheels. As the rear wheels are located further back behind their conventional position relative to the user's seat, the amputee user must reach further back with each propulsion stroke to push each wheel forward. This repetitive and strained movement often results in shoulder and rotator cuff injuries.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

It is an object of the present invention to provide an improved wheelchair and/or a stabiliser for stabilising a wheelchair for use by a lower-limb amputee or a person suffering any other form of disproportionate weight loss or weight reduction in one or both of the lower extremities relative to the torso and head, or to at least provide the public with a useful choice.

### SUMMARY OF THE INVENTION

In a first aspect, the present invention broadly consists in a stabilised wheelchair configured for a user suffering lower extremity weight loss comprising: a frame that supports a seat and which is moveable over the ground surface by a set of manually operable rear propulsion wheels and one or more forward steering wheels, and a stabiliser assembly comprising a weight device that is releasably secured to the frame of the wheelchair by a mounting assembly at a position forward of the rotation axis of the rear propulsion wheels of the wheelchair and which has a weight that is sufficient to counterbalance the user's lower extremity weight loss to maintain fore-aft stability of the wheelchair in use.

In one form, the weight device of the stabiliser assembly may have a fixed weight. In another form, the weight device of the stabiliser assembly may have an adjustable weight.

Preferably, the weight device of the stabiliser assembly may be positioned forward of the fulcrum balance point of the wheelchair.

In one form, the weight of the stabiliser assembly may be symmetrically distributed in the lateral direction relative to the midline of the wheelchair to maintain lateral stability of the wheelchair in normal use for a user suffering a symmetrical lower extremity weight loss relative to their midsagittal plane. For example, the weight device may be located centrally relative to the left and right side of the wheelchair.

In another form, the weight of the stabiliser assembly may be asymmetrically distributed in the lateral direction relative to the midline of the wheelchair to maintain lateral stability of the wheelchair in normal use for a user suffering an asymmetrical lower extremity weight loss relative to their midsagittal plane. In one example, the weight device may be positioned in an offset location toward either the left or right side of the wheelchair. In another example, the stabiliser assembly may comprise a left-side weight device located toward the left side of the wheelchair and a right-side weight device located toward the right side of the wheelchair, and where the weights of each weight device differ to provide an offset weight distribution relative to the midline of the wheelchair.

In one form, the mounting assembly may be configured to releasably secure the weight device directly to a footrest assembly of the wheelchair.

In another form, the mounting assembly may be configured to releasably secure the weight device to a part of a frame of the wheelchair.

In one example, the mounting assembly may comprise a support frame that is releasably mounted to the wheelchair frame and the weight device is fixed directly to the support frame.

In another example, the mounting assembly may comprise a support frame that is releasably mounted to the wheelchair frame and the weight device is releasably secured to the support frame via an operable coupling assembly.

Preferably, the coupling assembly may comprise a platform that is fixed to the support frame and which is arranged to support an underside of the weight device and wherein the weight device is releasably securable to the platform via an operable locking mechanism. In one form, the operable locking mechanism may comprise an operable locking pin provided on the weight device that is releasably engageable with a complimentary locking aperture provided on the platform. In another form, the operable locking mechanism may comprise an operable locking pin provided on the platform that is releasably engageable with a complimentary locking aperture provided on the weight device.

Preferably, the frame of the wheelchair may comprise left and right support struts to which a footrest assembly is releasably mountable and the support frame of the mounting assembly of the stabiliser assembly may be releasably secured to the left and right support struts in place of the footrest assembly. More preferably, the support frame of the mounting assembly may comprise: a substantially U-shaped vertical support frame comprising two spaced-apart left and right substantially upright members being coupled together at their bottom ends by a cross member, and a substantially U-shaped horizontal sub-frame extends from the cross-member of the vertical support frame at an angle that is substantially perpendicular to the orientation of the left and right upright members of the vertical support frame. By way of example, the top ends of the upright members of the vertical support frame may be configured for releasably securing with or into complimentary coupling systems or receiving apertures provided on the left and right support struts of the wheelchair frame:

In one form, the weight device of the stabiliser assembly may comprise a housing that is configured to receive and retain one or more weight components. Preferably, the housing of the weight device may comprise top and bottom opposed plates between which one or more weight components in the form of weight plates are stacked, and the top and bottom plates of the housing and weight plates are secured together via one or more fixing components.

In another form, the weight device may be in the form of a heavy footrest assembly, the weight of the footrest assembly being sufficient to counterbalance the user's lower extremity weight loss to maintain fore-aft stability of the wheelchair in use. In one example, the heavy footrest assembly may comprise solid framing that is formed from a heavy material. In another example, the heavy footrest assembly may comprise a hollow framing that is ballasted with a ballast material.

Preferably, the weight of the weight device may be selected based at least partly on the weight of the lower extremity weight loss and the position of the weight device relative to the fulcrum balance point.

By way of example, the frame of the wheelchair may be fixed or collapsible.

In a second aspect, the present invention broadly consists in a stabiliser assembly configured for installation on a wheelchair for use by a user suffering lower extremity weight loss, the wheelchair at least having a pair of rear propulsion wheels, the stabiliser assembly comprising: a weight device or devices; and a mounting assembly for releasably securing the weight device(s) to the wheelchair at a position forward of the rotation axis of the rear propulsion wheels of the wheelchair, and wherein the weight of the weight device(s) is sufficient to counterbalance the user's lower extremity weight loss to maintain fore-aft stability of the wheelchair in use.

In one form, the weight device(s) may have a fixed weight. In another form, the weight device(s) may have an adjustable weight.

Preferably, the mounting assembly may be configured to secure the weight device(s) at a position forward of the fulcrum balance point of the wheelchair.

In one form, the weight of the stabiliser assembly in use may be configured to be symmetrically distributed in the lateral direction relative to the midline of the wheelchair to maintain lateral stability of the wheelchair in normal use for a user suffering a symmetrical lower extremity weight loss relative to their midsagittal plane. In one example, the stabiliser assembly may be configured such that the weight device(s) are located centrally relative to the left and right side of the wheelchair in use.

In another form, the weight of the stabiliser assembly in use may be configured to be asymmetrically distributed in the lateral direction relative to the midline of the wheelchair to maintain lateral stability of the wheelchair in normal use for a user suffering an asymmetrical lower extremity weight loss relative to their midsagittal plane. In one example, the stabiliser assembly may be configured such that the weight device(s) are positioned in an offset location toward either the left or right side of the wheelchair. In another example, the stabiliser assembly may comprise a left-side weight device and a right-side weight device, and the stabiliser assembly may be configured such that the left-side weight device is located toward the left side of the wheelchair and the right-side weight device is located toward the right side of the wheelchair, and where the weights of each weight device differ to provide an offset weight distribution relative to the midline of the wheelchair in use.

In one form, the mounting assembly may be configured to releasably secure the weight device(s) directly to a footrest assembly of the wheelchair in use.

In another form, the mounting assembly may be configured to releasably secure the weight device(s) to a part of a frame of the wheelchair in use. In one example, the mounting assembly may comprises a support frame that is releasably mountable to the wheelchair frame and the weight device(s) are fixed directly to the support frame. In another example, the mounting assembly may comprise a support frame that is releasably mountable to the wheelchair frame and the weight device(s) are releasably secured to the support frame via an operable coupling assembly.

Preferably, the coupling assembly may comprise a platform that is fixed to the support frame and which is arranged to support an underside of the weight device(s) and wherein the weight device(s) are releasably securable to the platform via an operable locking mechanism(s). In one example, each operable locking mechanism comprises an operable locking pin provided on the weight device that is releasably engageable with a complimentary locking aperture provided on the platform. In another example, each operable locking mechanism comprises an operable locking pin provided on the platform that is releasably engageable with a complimentary locking aperture provided on the weight device.

In one form, the frame of the wheelchair may comprise left and right support struts to which a footrest assembly is releasably mountable and the support frame of the mounting assembly of the stabiliser assembly is configured to be releasably securable to the left and right support struts in place of the footrest assembly in use. Preferably, the support frame of the mounting assembly may comprise: a substantially U-shaped vertical support frame comprising two spaced-apart left and right substantially upright members being coupled together at their bottom ends by a cross member, and a substantially U-shaped horizontal sub-frame extends from the cross-member of the vertical support frame at an angle that is substantially perpendicular to the orientation of the left and right upright members of the vertical support frame. More preferably, the top ends of the upright members of the vertical support frame are configured for releasably securing with or into complimentary coupling systems or receiving apertures provided on the left and right support struts of the wheelchair frame in use.

In one form, the weight device(s) of the stabiliser assembly may comprise a housing that is configured to receive and retain one or more weight components. Preferably, the housing of the weight device(s) may comprise top and bottom opposed plates between which one or more weight components in the form of weight plates are stacked, and the top and bottom plates of the housing and weight plates are secured together via one or more fixing components.

In another form, the weight device may be in the form of a heavy footrest assembly, the weight of the footrest assembly being sufficient to counterbalance the user's lower extremity weight loss to maintain fore-aft stability of the wheelchair in use. In one example, the heavy footrest assembly may comprise solid framing that is formed from a heavy material. In another example, the heavy footrest assembly may comprise a hollow framing that is ballasted with a ballast material.

Preferably, the weight of the weight device(s) may be selected based at least partly on the weight of the lower extremity weight loss and the position of the weight device relative to the fulcrum balance point.

In a third aspect, the present invention may broadly consist in a method of stabilising a wheelchair for a user suffering a lower extremity weight loss, the wheelchair comprising a frame that supports a seat and which is moveable over the ground surface by a set of manually operable rear propulsion wheels and one or more forward steering wheels, comprising: determining a counterbalance weight for a weight device to be mounted at a position forward of the rotation axis of the rear propulsion wheels of the wheelchair that will be sufficient to counterbalance the user's lower extremity weight loss to maintain fore-aft stability of the wheelchair in use; and mounting a weight device or devices having the determined counterbalance weight to the wheelchair at a position forward of the rotation axis of the rear propulsion wheels of the wheelchair.

Preferably, the step of determining the counterbalance weight comprises selecting the weight based at least partly on the weight of the lower extremity weight loss and the intended position of the weight device relative to the rotation axis of the rear propulsion wheels.

The third aspect of the invention may have any one or more features mentioned in respect of the first and second aspects of the invention.

Other aspects of the invention follow.

In another aspect, the present invention broadly consists in a stabiliser assembly for installation on a wheelchair at least having a pair of rear propulsion wheels, comprising: a weight device having a predetermined or adjustable weight; and a mounting assembly for releasably securing the weight device to the wheelchair at a position forward of the rotation axis of the rear propulsion wheels of the wheelchair.

In another aspect, the present invention broadly consists in a stabiliser assembly for installation on a wheelchair at least having a pair of rear propulsion wheels, comprising: one or more weight devices having a predetermined or adjustable weight; and a mounting assembly for releasably securing the weight device(s) to the wheelchair at a position forward of the rotation axis of the rear propulsion wheels of the wheelchair.

In another aspect, the present invention broadly consists in a wheelchair comprising a frame that supports a seat and which is moveable over the ground surface by a set of manually operable rear propulsion wheels and one or more forward steering wheels, and wherein a stabiliser assembly of either the first or second aspects of the invention is releasably secured to the frame of the wheelchair at a position forward of the rotation axis of the rear propulsion wheels of the wheelchair.

The phrase “fulcrum balance point” as used in this specification and claims, unless the context suggests otherwise, is intended to mean the fulcrum axis of the wheelchair relative to the fore-aft, which typically corresponds to the location of the axis of rotation of the rear wheels.

The phrase “lower extremity weight loss” as used in this specification and claims, unless the context suggests otherwise, is intended to relate to the weight loss suffered by a person due to amputation of one or both of their lower extremities, or some other form of disproportionate weight loss to the lower extremities, such as severe muscle loss or similar.

The term “comprising” as used in this specification and claims means “consisting at least in part of”. When interpreting each statement in this specification and indicative independent claims that includes the term “comprising”, features other than that or those prefaced by the term may also be present. Related terms such as “comprise” and “comprises” are to be interpreted in the same manner.

As used herein the term “and/or” means “and” or “or”, or both.

As used herein “(s)” following a noun means the plural and/or singular forms of the noun.

The invention consists in the foregoing and also envisages constructions of which the following gives examples only.

### BRIEF DESCRIPTION OF THE DRAWINGS

Preferred embodiments of the invention will be described by way of example only and with reference to the drawings, in which:

FIG. 1 shows a top-side perspective view of a conventional wheelchair with an installed footrest assembly;

FIG. 2a shows a perspective view of a conventional wheelchair having an installed stabiliser assembly in accordance with a first embodiment of the invention, which has a centralised configuration;

FIG. 2b shows a perspective view of a conventional wheelchair having an installed stabiliser assembly in accordance with a second embodiment of the invention, which has an offset configuration;

FIGS. 3A and 3B show top-side perspective and front elevation views respectively of a partially installed stabiliser assembly in accordance with an embodiment of the invention;

FIGS. 4A and 4B show top-side perspective and front elevation exploded views respectively of a weight device of the stabiliser assembly of FIGS. 3A and 3B;

FIGS. 5A-5C show top-side perspective, underside perspective, and front elevation views respectively of a coupling assembly for securing a weight device to a support frame of the stabiliser assembly in accordance with an embodiment of the invention;

FIGS. 6A and 6B show side and front elevation cross-sectional views of the configuration of the coupling assembly of FIGS. 5A-5C, and in particular an operable locking mechanism for coupling and uncoupling of the coupling assembly;

FIGS. 7A and 7B show perspective and side views of a locking pin of the locking mechanism of the coupling assembly in an open and unlocked configuration;

FIGS. 8A and 8B show the locking pin of FIGS. 7A and 7B in a closed and locked configuration;

FIGS. 9A and 9B show top-side perspective and front elevation views of the stabiliser assembly in accordance with another embodiment of the invention with an offset weight configuration; and

FIGS. 10A and 10B show top-side perspective and front elevation exploded views of a weight device of the stabiliser assembly of FIGS. 9A and 9B.

### DETAILED DESCRIPTION OF PREFERRED EMBODIMENTS

### Overview

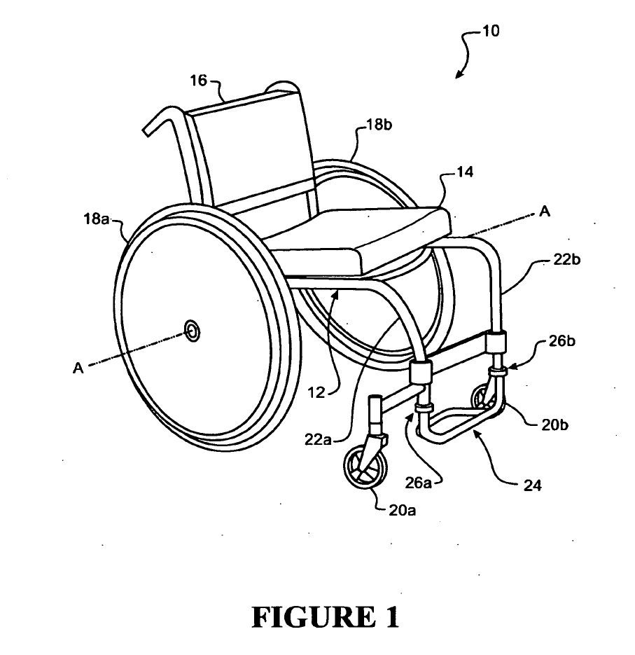

The present invention relates to a stabiliser assembly for releasably securing to a conventional wheelchair. The purpose of the stabiliser device is to provide a counterbalance for stabilising the wheelchair when used by a lower-limb amputee or a person suffering any other form of disproportionate lower extremity weight loss relative to the torso and head, including but not limited to muscle loss. The lower extremity weight loss may be symmetrical or asymmetrical relative to the midsagittal plane. By way of example only, FIG. 1 shows one possible conventional wheelchair to which the stabiliser assembly may be attached or retrofitted, although it will be appreciated that any other type of conventional wheelchair may alternatively be used in other embodiments of the stabiliser assembly. The wheelchair in FIG. 1 is a fixed frame wheelchair, although it will be appreciated that the stabiliser assembly may also be applied to collapsible or folding framed wheelchairs if desired.

In brief, the conventional wheelchair 10 comprises a frame 12 that supports a seat 14 and backrest 16. A pair of left and right manually operable propulsion wheels 18a,18b and a pair of forward left and right castor wheels 20a,20b are coupled to the frame 14 to enable the wheelchair to roll on a ground surface. As is known, propulsion of the wheelchair is provided by the user pushing the handrails coupled to the rear propulsion wheels 18a,18b to rotate the wheels and manoeuvre the wheelchair accordingly in the desired direction and speed. In this wheelchair 10, the frame 12 comprises left and right leg and/or foot rest support struts 22a,22b from which a central lower leg and/or foot rest assembly 24 (herein: footrest assembly) is releasably coupled at points 26a and 26b via clamps or operable locking or coupling assemblies. In other forms, separate left and right leg and/or foot rests may be individually attached to their respective vertical support struts 22a,22b.

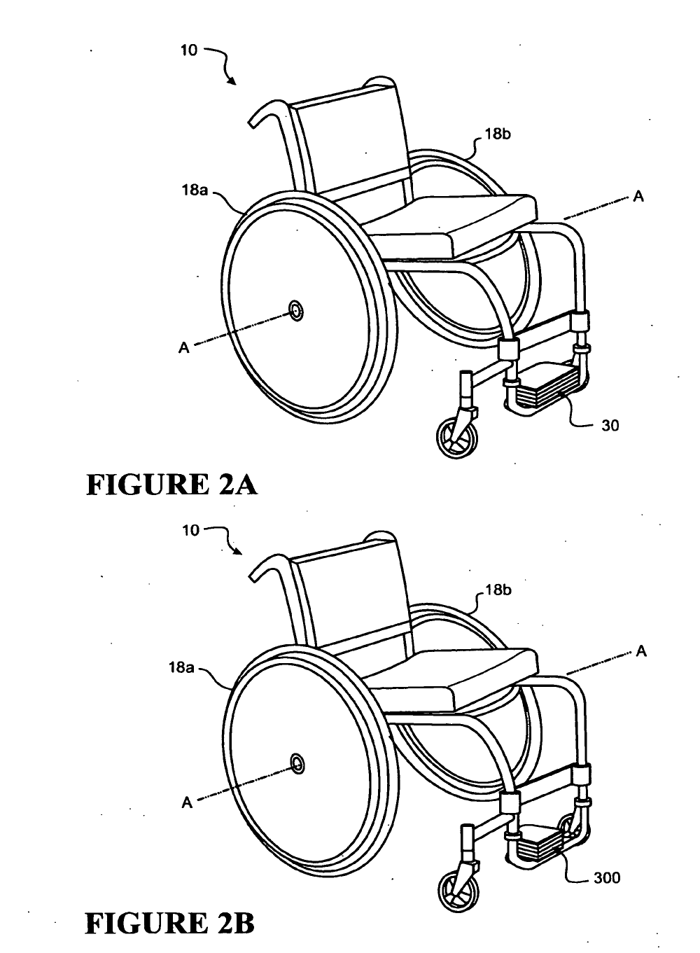

In a preferred embodiment, the stabiliser assembly is configured to replace the footrest assembly 24 as shown generally by arrows 30 and 300 in FIGS. 2a and 2b respectively. In alternative embodiments, the stabiliser assembly may be configured to releasably couple directly to a footrest assembly rather than replace the footrest assembly. As shown, the location of the stabiliser assembly is configured to counterbalance the weight of the wheelchair about its fulcrum balance point so as to stabilise the wheelchair from tipping backward when a user accelerates from rest. In the preferred form, the stabiliser assembly 30 is preferably positioned at any point forward of the fulcrum balance point of the wheelchair. In preferred embodiments, the position and location of the stabiliser assembly is at or toward the footrest assembly or replaces the footrest assembly so as to replace the weight that is missing from the amputated limb or limbs and therefore is located forwardly and downwardly relative of the seat 14 of the wheelchair. However, it will be appreciated that any position that provides a counterbalancing effect for stabilising with respect to the weight disbursement and distribution of the wheelchair could be used, including any position generally forward of the axis of rotation AA of the rear propulsion wheels 18a,18b.

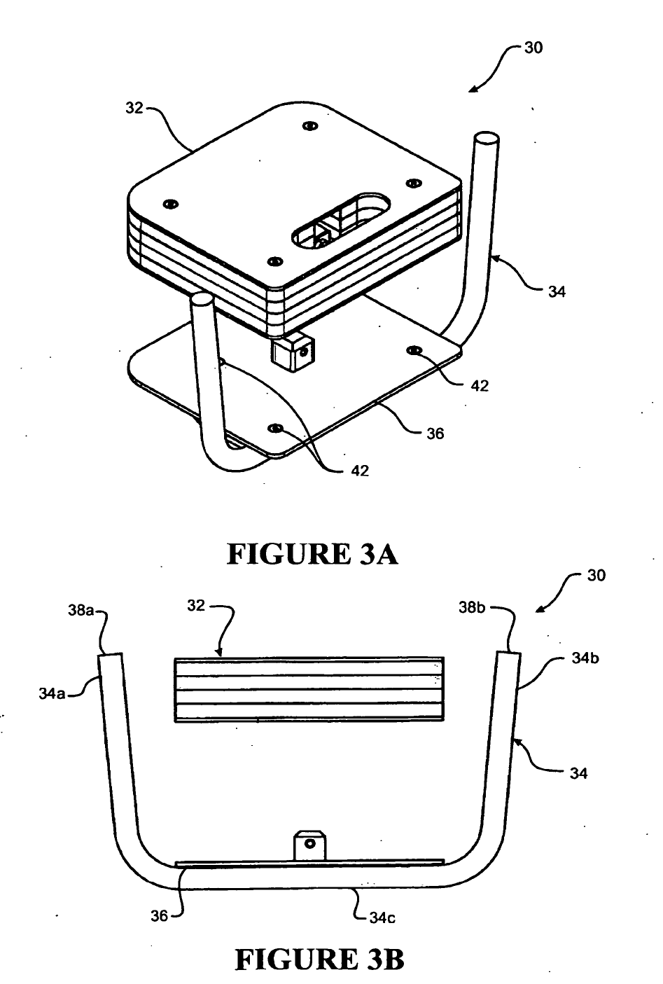

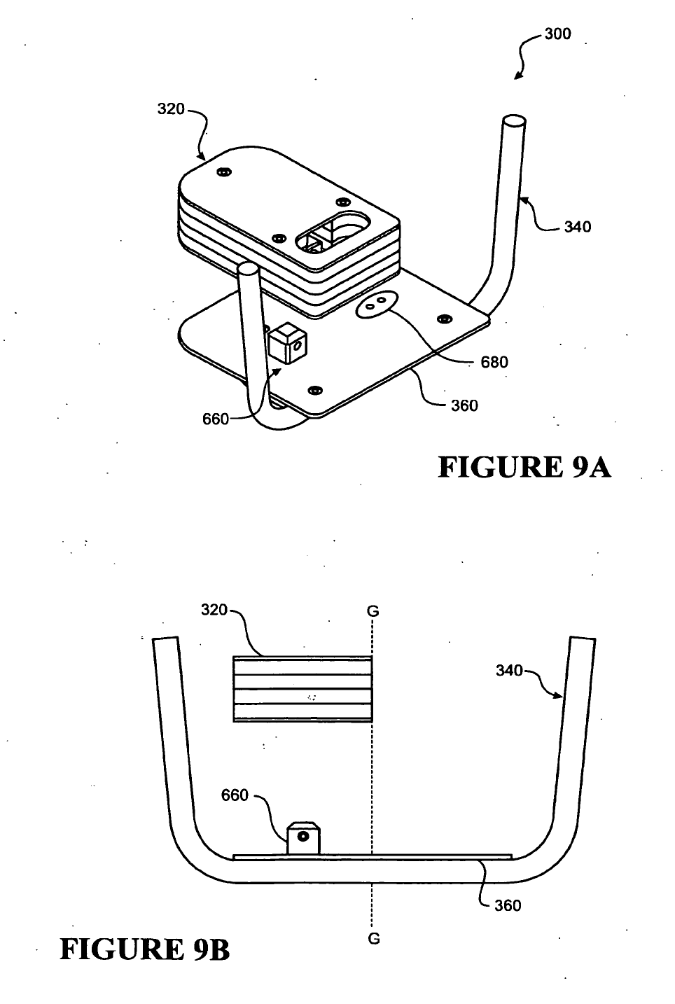

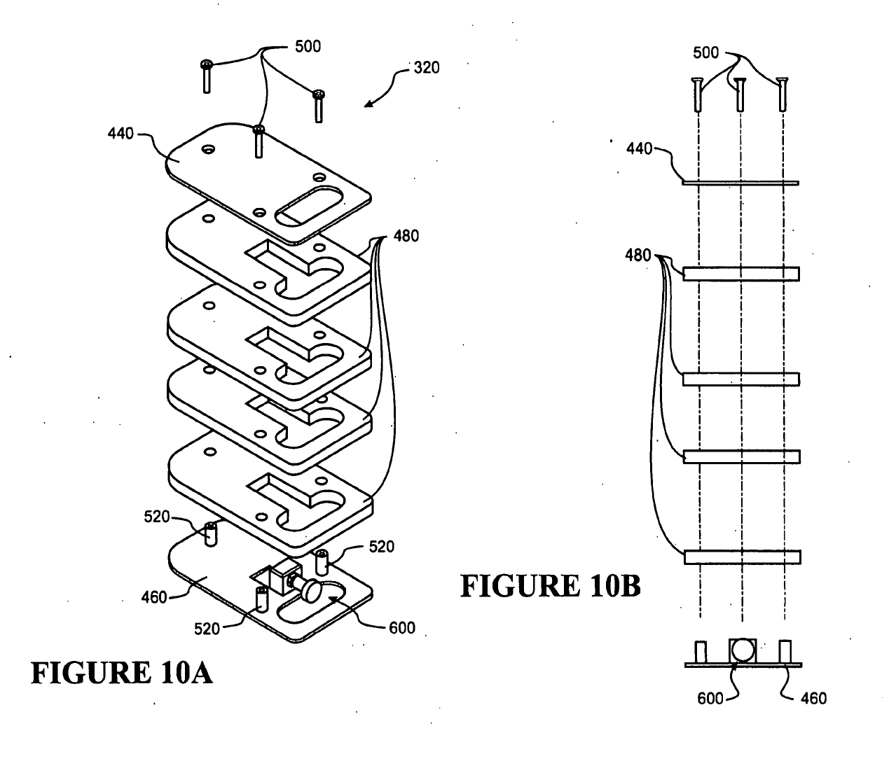

Two embodiments of the stabiliser assembly will now be described by way of example. The first embodiment with reference to FIGS. 3A-8B is a laterally (with respect to the left and right side of the wheel chair) balanced and centralised configuration of the stabiliser assembly in which the weight of the device is evenly distributed relative to the left and right side of the centre of the wheelchair as is shown installed at 30 in FIG. 2A, and is primarily to provide or restore fore-aft stability. This centralised configuration is suited for use by persons having symmetrical lower extremity weight loss relative to the midsagittal plane, for example persons having two amputated lower limbs to the same degree, or disproportionate muscle loss of the legs (relative to the head and torso) that is substantially equal on both sides. The second embodiment with reference to FIGS. 9A-10B relates to an offset configuration of the stabiliser assembly in which the weight device can be offset toward either the left or right sides of the wheelchair, or can be configured with a differential left-right side weight distribution, and is suited for use by persons having an asymmetrical lower extremity weight loss, for example persons having either one left or right amputated lower limb, or in which the both lower limbs have been amputated but to different degrees, or where the person is suffering disproportionate muscle loss to one or both legs (relative to the head and torso) and which results in asymmetrical weight loss relative to the midsagittal plane. The second embodiment is shown installed at 300 in FIG. 2b, and provides or restores both fore-aft stability and lateral stability.

### First Embodiment

### Stabiliser Assembly—Centralised Configuration

The first embodiment stabiliser assembly 30 comprises a weight device indicated by 32 that is releasably securable to a wheelchair by a mounting assembly. In this embodiment, the mounting assembly comprises a support frame or structure 34 having a base platform 36 onto which the weight device is supported. As shown with reference to FIGS. 2, 3A and 3B, the support frame 34 is configured for retrofitting to the frame or framework of a conventional wheelchair. In particular, the support frame 34 is configured to replace the existing footrest 24 (see FIG. 1) of a conventional wheelchair and releasably couple to the leg and/or foot rest struts 22a,22b of the wheelchair in a manner similar to how the footrest is coupled and installed.

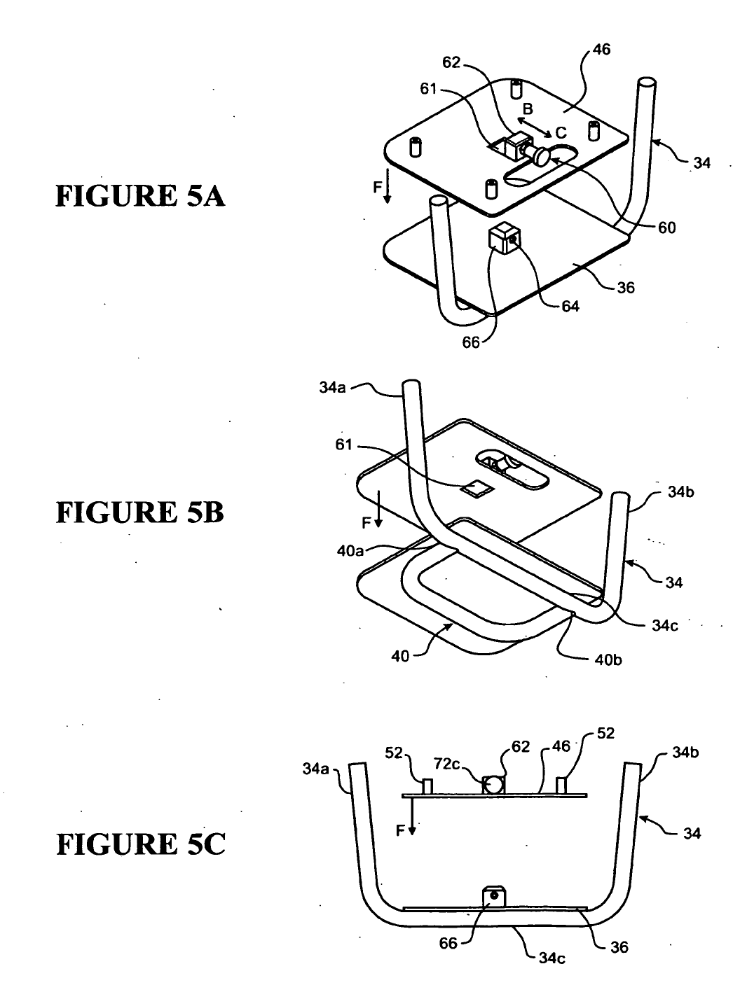

By way of example, in this embodiment the support frame 34 is in the form of a substantially vertically orientated U-shaped component having a circular cross-section, although this is not essential. The U-shaped member comprises two substantially upright left 34a and right 34b members that are coupled together at their lower or bottom ends by a cross-member 34c that is integrally formed or attached to the respective bottom ends of the upright members. The free or top ends of the upright members 34a,34b, indicated at 38a and 38b, are configured to be releasably received and retained within complimentary sleeves or elongate apertures formed in the ends of the leg and/or foot rest struts 22a,22b of the frame of a conventional wheelchair and are locked in place via a clamp or other locking mechanism as is known with regard to leg rest assemblies. With reference to FIG. 5B, the preferred form support frame 34 also comprises as sub-frame component 40 that extends substantially perpendicularly to the upright members from the cross member 34c. In this embodiment, the substantially horizontally orientated sub-frame component 40 is also a U-shaped member having a circular cross-section. The free ends 40a,40b of the sub-frame 40 are integrally formed with, or attached or fixed to, the cross member 34c of the vertical support frame 34.

Reverting to FIG. 3A, the base platform 36 is substantially rectangular and has rounded corners. Preferably, it is attached to the cross member 34c and the sub-frame member 40 by one or more fastening components 42, which may be screws, bolts or any other fixing device or component. It will be appreciated that the platform may alternatively be welded or otherwise fixed to the support frame 34 as desired. The base platform is arranged to have an orientation that is substantially horizontal relative to the ground surface, although this is not essential. As will be explained in more detail later, the weight device 32 is releasably securable to the support frame 34 by a coupling assembly. In this embodiment, the coupling assembly comprises a supporting base platform 36 and an operable locking mechanism.

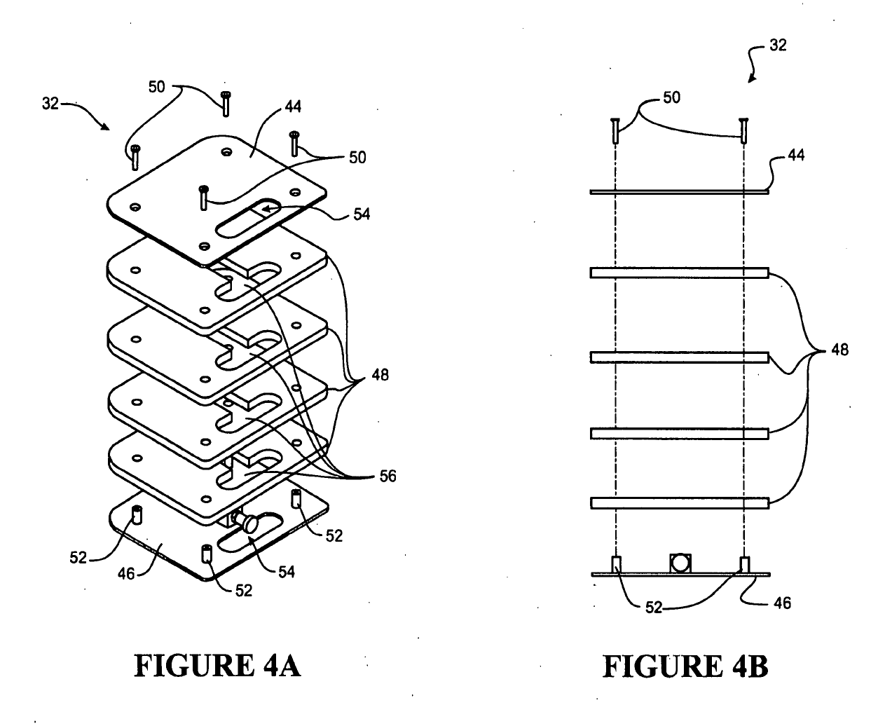

Referring to FIGS. 4A and 4B, the weight device 32 will now be described in further detail. The weight device is intended to provide a predetermined or adjustable weight for counterbalancing the wheelchair when the stabiliser assembly is installed on the wheelchair. The amount of weight can be varied or customised to a particular individual and wheelchair design so as to provide the adequate counterbalance to stabilise the wheelchair in use. Preferably, the selected weight does not overly increase the total weight of the wheelchair so as to make its use more difficult and tiring to use, or overbalance the wheelchair toward the front end too much as to cause instability and tipping forward of the wheelchair in use. Various factors may dictate the weight employed, including, but not limited to, the nature of the lower extremity weight loss, the overall size of the user, the intended fulcrum balance point of the wheelchair as designed for a user without a disproportionate weight loss of the lower extremities relative to the head and torso, the location of the weight device relative to the fulcrum balance point, and the like. For amputees, the nature of the lower extremity weight loss may include whether one or both limbs are amputated, the extent or degree of amputation, and/or the weight of the amputated limbs. For non-amputees suffering disproportionate lower extremity weight loss due to muscle loss or similar, the nature of that weight loss may include the weight of the muscle lost. Typically the weight of the weight device is calculated or selected as a counterbalance to provide or restore fore-aft stability of the wheelchair based at least partly on the weight of the lower extremity weight loss and the position of the weight device relative to the fulcrum balance point. It will be appreciated that often sufficient counterbalance force for fore-aft stability is provided with a weight device weighing less than the lower extremity weight loss of the wheelchair user as the counterbalance force of the weight device is leveraged based on its position or distance from the fulcrum balance point, such as the rotation axis of the rear wheels. In referring to fore-aft stability, this is generally considered to be where the front wheel or wheels of the wheelchair maintain contact with the ground surface with no or negligible lifting during normal wheelchair use, including accelerating from rest.

In this preferred form, the weight device 32 comprises a housing or casing structure that is configured or adapted to retain and receive one or more weight components. In this embodiment, the housing comprises top 44 and bottom 46 end plates between which one or more weight components 48 are sandwiched. In this embodiment, the weight components 48 are in the form of identical: weight plates, although this is not essential. The top 44 and bottom 46 end plates and the weight plates 48 are preferably substantially planar with rectangular upper and lower planar surfaces that abut with each other in a stacking arrangement. The weight plates 48 may be thicker than the top 44 and bottom 46 end plates. In the preferred form, the top 44 and bottom 46 end plates and weight plates 48 are formed from steel although any other suitable material could alternatively be used. In alternative forms, the end plates 44,46 may be formed from different material, such as aluminium or polymer plastic, to that of the weight plates 48. In this embodiment, the weight device 32 is weight adjustable in that the number of weight plates 48 in the vertical stack may be varied to alter the weight of the device as desired. The more plates 48 used, the higher the weight of the device 32.

The housing and weight plates 48 are fixed together via a fixing system. In this embodiment, the fixing system is provided in the form of fixing components, such as bolts or screws 50 that are arranged to extend through complimentary aligned apertures in each of the four corners of the top and bottom end plates 44,46 and weight plates 48. In this embodiment, the bolts or screws 50 are arranged to extend though the top end plate 44 and the one or more weight plates 48 and are arranged to be received and retained via a screw-thread in complimentary internally screw-threaded elongate mounting apertures 52 that extend upwardly in each of the four corners from the bottom end plate 46. In operation, to adjust the weight of the weight device, the screw or bolts 50 of the fixing system may be released from their respective mounting apertures 52 via a screw turning to thereby allow one or more of the weight plates to be removed or alternatively additional plates to be inserted in the stack as required to either reduce or increase the weight as is necessary.

In other embodiments, the housing of the weight device may be an openable enclosure or casing having one or more internal cavities or recesses within which one or more weight components or weight material, such as sand or the like, may be received and retained. The enclosure may be opened in order to access the cavities for installing or removing weight components or material to adjust the weight of the weight device as is necessary. In further alternative embodiments, it will be appreciated that the weight device be one integral component having a fixed or predetermined weight and which is releasably mountable to the support frame or directly to the wheelchair footrest or other part of the wheelchair framework.

As previously mentioned, in this embodiment the coupling assembly for releasably mounting or securing the weight device 32 to the support frame 34 includes a base platform 36 upon which the weight device is supported and is securable in place via an operable locking mechanism that couples the weight device 32 to the base platform 36. In this embodiment, an operable part of the locking mechanism is substantially concealed within the weight device 32 when installed. This configuration is enabled by elongate access apertures or slots 54 that are provided in each of the top and bottom end plates 44,46 and additionally aligned shaped apertures 56 provided centrally within each of the weight plates 48. In this embodiment, the apertures 56 in each of the weight plates 48 are substantially T-shaped with the cross-bar portion of the T-shape conforming to the shape and size of the elongate access slots 54 of the top and bottom end plates and the central stem of the T-shaped apertures extending inwardly toward the centre of the plate. In operation, the elongate access apertures 54 and corresponding cross-bar portion of the T-shaped apertures 56 of the weight plates 48 cooperate to provide an access for the hand of the user to operate a locking pin of the locking mechanism, which will be described in further detail later. The elongate cavity collectively provided by the stem portion of the T-shape apertures 56 of the weight plate in between the top and bottom end plates 44,46 provide a retaining space for receiving mounting components of the locking mechanism which support the locking pin.

Referring to FIGS. 5A-8B, the locking mechanism will be described in further detail. In brief, the components of locking mechanism are mounted on the bottom plate 46 of the weight device 32 and the base platform 36 that is fixed or attached to the support frame 34 of the stabiliser assembly. The locking mechanism comprises a slidable locking pin that is mounted for slidable movement in the direction indicated by arrows BC. The locking pin 60 is preferably slidably mounted within a mounting block 62 attached or fixed to the bottom plate 46 of the weight device. The locking bolt or pin 60 is arranged or configured to be received and retained within a complimentary locking aperture 64 that is provided within a mounting block 66 that is attached to or formed on the upper surface of the base platform 36. In this embodiment, the locking pin is biased by a biasing member or members in direction B into a locking position such that it protrudes from the mounting block 62 and into the locking aperture 64 to thereby lock or couple the weight device to the base platform 36. To release or unlock the locking mechanism, the user pulls the locking pin in direction C to thereby retract the locking pin 60 in direction C out of the locking aperture to enable the weight device to be removed from the base platform 36.

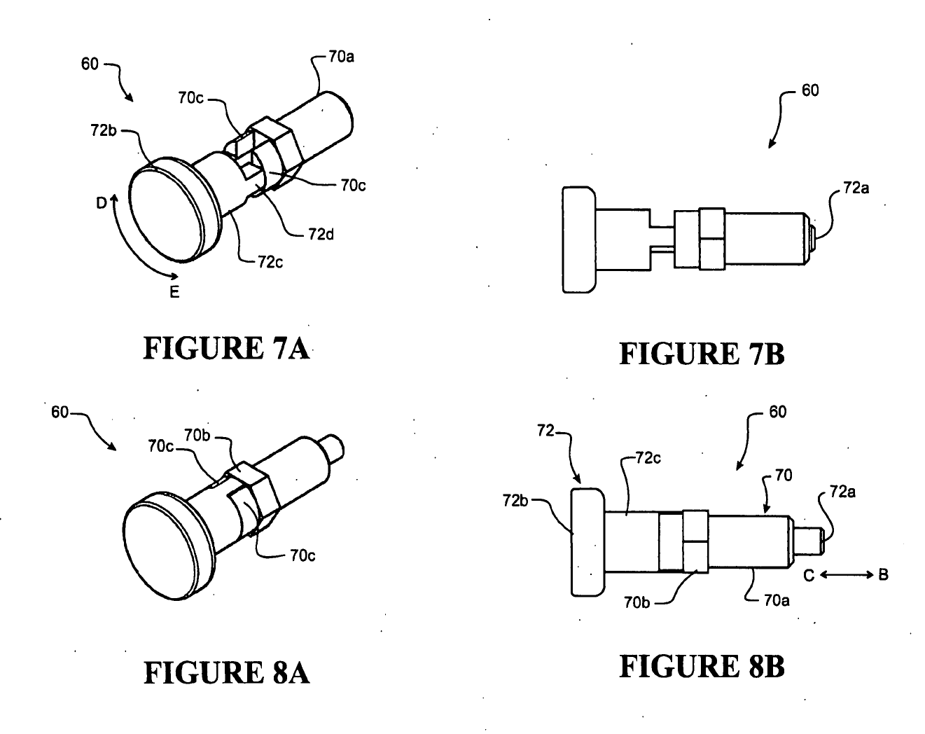

Referring to FIGS. 7A-8B, the preferred embodiment of the locking pin 60 will be explained further. Referring to FIGS. 8A and 8B, in this preferred embodiment the locking pin 60 comprises a fixed mounting part 70 and a moveable operating part generally indicated by 72. In operation, the mounting part 70 is arranged to be fixed or received and retained within the mounting block 62 of the bottom plate 46 of the weight device 32. By way of example, the mounting part 70 comprises a screw-threaded cylindrical portion 70a that is integrally formed with a hexagon-shaped head end 70b. In operation, the threaded cylindrical portion 70a is screw-threaded into a complimentary internally threaded cylindrical aperture formed within the mounting block 62 of the bottom end plate 46 of the weight device 32. Screw thread installation or removal of the pin from the mounting block 62 can be achieved via rotation of the hex head end in the appropriate direction.

In the preferred embodiment, the operating part 72 of the locking pin 60 is removably mounted in the mounting part 70 for slidable movement back and forth in the direction shown by the arrows B and C. The operating part 72 comprises an engagement portion 72a that is cylindrical and slidably extendible or retractable within a cylindrical aperture extending through the mounting portion 70a of the mounting part 70 of the locking pin 60. The other end of the operating part 72 comprises a manually operable knob portion 72b in the form of a circular disc having a larger diameter than the remaining portions of the locking pin so as to enable a user to grip and pull the knob 72b with two fingers, for example. The engagement portion 72a and knob portion 72b of the operating part 72 are connected together via a connecting portion 72c.

FIGS. 8A and 8B show the locking pin 60 in an engaged and locking position with the engagement portion 72a extending from the mounting portion 70a, while FIGS. 7A and 7B show the locking pin in a non-engaged and unlocked position with the engagement portion 72a retracted substantially into the mounting portion 72a. In a preferred embodiment, the operating part 72 is biased in direction B within the mounting part 70 by one or more springs or other resilient components so as to extend the engagement portion 72a from the end of the mounting portion 70a of the mounting part 70 into a locking position for engagement within the complimentary locking aperture of the mounting block 66 of the base platform 36. Pulling of the operating knob 72b in direction C results in engagement portion 72a being retracted back within the mounting portion 70a as shown in FIG. 7B such that it does not substantially protrude from the end of the mounting portion 70a.

Optionally, in this embodiment shown the locking pin 60 is operable so as to enable the locking pin to be fixed into a non-engaged or unlocked position as shown in FIGS. 7A and 7B to hold against the spring bias if necessary for a desired period of time during installation or removal of the weight device into the mounting assembly. This capability is enabled via rotation of the operating knob 72b in either direction shown by arrows C or D as will now be explained. In particular, the operating part 72 is rotatable relative to the mounting part 70 about a rotation axis extending along the central longitudinal axis of the locking pin. In this embodiment, the connecting portion 72c of the operating part 72 is substantially cylindrical but also includes an engagement section or tab 72d that is arranged to be received and retained within a complimentary slot or recess formed between two opposed protrusions 70c extending from the hex head end 70b of the mounting part. When the tab 72d is aligned with the complimentary slot or aperture formed by or between the protrusions 70c, the operating part 72 is spring biased toward the locking position in direction B and may be manually retracted into an unlocked position by a user pulling the knob 72b in direction C as previously described. With the tab 72d aligned with its complimentary recess in the mounting part 70, the locking pin would revert back to the locking position in the absence of any pulling pressure on the knob 72b by the user. In some situations, in may be desirable to temporarily fix the locking pin into the unlocked position while installation or removal of the weight device from the mounting assembly is occurring. To do this, the user may additionally, upon retraction of the locking pin, rotate the knob 72b in either direction D or E so as to mis-align the tab 72d such that it rests on the exterior surface of the protrusions 70c and thereby hold the locking pin in a non-engaged retracted position. To enable release of the locking pin into a locked position, the knob 72 must be rotated so as to bring the tab 72d back into alignment with its complementary receiving slot on the mounting part 70.

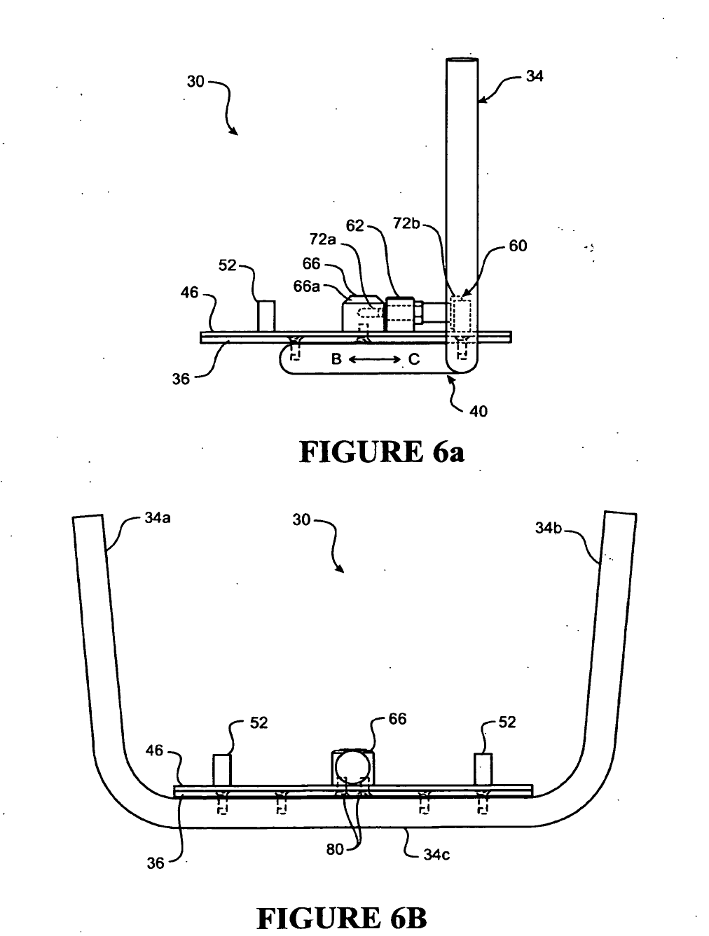

Referring to FIGS. 6A and 6B, the bottom plate 46 of the weight device 32 is shown coupled to the base platform 36 via the engaged locking mechanism. For clarity, the other components of the weight device, such as the weight plate 48 and top end plate 44 are not shown. As shown, the engagement portion 72a of the locking pin 60 is retained and received within a complimentary locking aperture of the mounting component 66 of the base platform 36. In this preferred embodiment, the upper peripheral edges 66a of the mounting block 66 on the base platform are angled, curved or otherwise shaped to act as camming surfaces such that when the weight device and protruding engagement portion 72a of the locking pin 60 is lowered onto the base platform 36 in direction F (shown in FIGS. 5A-5C), the engagement portion is pushed to retract back into its mounting part 70a due to engagement or contact with the camming surfaces. Upon full installation or contact of the bottom end plate 46 of the weight device with the base platform 36, the engagement portion 72a of the locking pin 60 then springs back into engagement into the complimentary locking aperture of the mounting block 66 to thereby lock the weight device to the base platform 36. The locking mechanism may be released by pulling the knob 72b of the operating part of the locking pin 60 in direction C to thereby withdraw the engagement portion from the locking aperture as previously explained. As shown in FIGS. 5A and 5B, a receiving aperture 61 is provided in the bottom end plate 46 through which the mounting block 66 of the base platform 36 extends. As shown in FIG. 6B, the mounting block 66 is secured to the base platform 36 via one or more fixing components 80, such as screws, bolts or the like

It will be appreciated that other locking mechanisms could alternatively used, and for example the locking pin may alternatively be provided on the base platform with a complimentary locking aperture being provided in the weight device in an opposite arrangement if desired.

### Second Embodiment

### Stabiliser Assembly—Offset Configuration

For particular individuals, it may be desirable to configure the stabiliser assembly such that the overall weight is offset in the lateral direction toward either the left or right side relative to a central plane (or midline) extending through the center of the wheelchair.

This offset configuration may be required in situations where the person using the wheelchair has asymmetrical lower extremity weight loss relative to the midsagittal plane, for example including where the person has one amputated limb, or different degrees of amputation on both lower limbs, or asymmetrical muscle loss to one or both legs, and therefore counterbalancing is not only required in the fore-aft direction (fore-aft stability) of the wheelchair, but also the lateral direction extending across from the left to right sides of the wheelchair (lateral stability).

FIGS. 9A-10B show a modified version of the stabiliser assembly that is capable of providing offset configuration of weight toward either the left or right sides of the wheelchair. The overall configuration and operation of the offset configuration is substantially the same as that previously described with respect to the first embodiment. The major difference is that the weight device 320 is approximately half the lateral width of the weight device 32 and the platform 360 of the support frame 340 is provided with a left side or right side mounting block 660.

As shown in FIGS. 9A and 9B, the offset configuration is for a right-sided weight device in which the mounting block 660 is installed on the right side of the base platform 360 relative to a central line GG of symmetry of the support frame. Alternatively, the mounting block 660 may be removed and installed with fixing devices via complimentary apertures 680 of the left side to change the configuration to a left-sided offset. The capabilities and functionality of the weight device and locking mechanism are otherwise the same as the first embodiment.

FIGS. 10A and 10B show exploded views of the half-sized version of the weight device 320 again with top 440 and bottom 460 end plates between which one or more weight plates 480 are sandwiched to provide an adjustable weight for counterbalancing the wheelchair device. In this configuration, three fixing components 500, such as bolts or screws are arranged to extend through complimentary aligned apertures in the top end plate 440 and weight plates 480 and are received in mounting cylinders 520 of the bottom end plate 460 and retained via screw-thread. The locking pin 600 and locking mechanism generally is also the same as the first embodiment.

It will also be appreciated that multiple weight devices having different weights may be installed on the base platform via separate coupling assemblies. In one possible embodiment, the base platform 360 may be configured to receive a left-side weight device and a right-side weight device, using the same type of coupling assemblies previously described. The total weight of both left and right side devices acting to counterbalance the fore-aft stability of the wheelchair (as in the first embodiment), and the differential or offset weight distribution relative to the lateral direction of the wheelchair acting to stabilise the wheelchair laterally, i.e. to prevent or minimise the risk of the wheelchair tipping over sideways during normal use.

### Other Example Alternative Embodiments and Features

The stabiliser assemblies of the first and second embodiments previously described are arranged as a retrofit assembly for replacing the existing footrest of a conventional wheelchair. It will be appreciated that the mounting assembly, such as the support frame, may be adapted to be releasably mountable to any type of wheelchair leg and/or foot rest support assemblies or units.

In alternative embodiments, it will be appreciated that the stabiliser assembly may have a mounting assembly that cooperates or releasably couples directly to an existing footrest assembly of a wheelchair, rather than replace that assembly. For example, in such embodiments, the stabilising assembly may comprise a mounting assembly that consists only of the base platform that may be releasably or otherwise be fixed to the existing footrest of the type shown at 24 in FIG. 1.

In other alternatives, the mounting assembly may be completely integral with the weight device such that the weight device can be directly attached to the footrest or other framework of the wheelchair via a coupling mechanism such as operable clamps or the like.

In other embodiments, the stabliliser assembly may be provided in the form of a releasable footrest assembly like or similar to that shown at 24 in FIG. 1, but which is made of heavy material such that it operates as a weight device having a weight that provides the required counterbalance. It such a form, the footrest assembly could be formed from solid members or framing, such as steel or iron to provide sufficient weight. Alternatively, the footrest assembly may be formed from hollow framing or members that are ballasted with a ballast material within. For example, the hollow framing may be formed from a light weight material like aluminium or carbon fibre, and the ballast material could be any suitable heavy material, whether concrete or a particulate material such as steel beads or similar.

In the embodiments described, the stabiliser assembly has been arranged for coupling in the region of the footrest assembly of the wheelchair or at a position forward of the seat and close to the ground to maximise the counterbalance effect. However, it will be appreciated that the stabiliser may be coupled or attached to the wheelchair at other locations that still provide a counterbalance effect. Other locations include anywhere forward of the rotation axis of the rear propulsion wheels and preferably below the seat level. More preferably, the location of the stabiliser should be forward of the fulcrum balance point of the wheelchair.

The materials used for constructing or forming the various stabilising assembly components may be steel, or any other metal, but it will be appreciated that other materials such as plastic or aluminium could be used to form some of the components.

The foregoing description of the invention includes preferred forms thereof. Modifications may be made thereto without departing from the scope of the invention as defined by the accompanying claims.

1. A stabilised wheelchair configured for a user suffering lower extremity weight loss comprising: a frame that supports a seat and which is moveable over the ground surface by a set of manually operable rear propulsion wheels and one or more forward steering wheels, and a stabiliser assembly comprising a weight device that is releasably secured to the frame of the wheelchair by a mounting assembly at a position forward of the rotation axis of the rear propulsion wheels of the wheelchair and which has a weight that is sufficient to counterbalance the user's lower extremity weight loss to maintain fore-aft stability of the wheelchair in use.

2. A stabilised wheelchair according to claim 1 wherein the weight device of the stabiliser assembly has a fixed weight.

3. A stabilised wheelchair according to claim 1 wherein the weight device of the stabiliser assembly has an adjustable weight.

4. A stabilised wheelchair according to any one of the preceding claims wherein the weight device of the stabiliser assembly is positioned forward of the fulcrum balance point of the wheelchair.

5. A stabilised wheelchair according to any one of the preceding claims wherein the weight of the stabiliser assembly is symmetrically distributed in the lateral direction relative to the midline of the wheelchair to maintain lateral stability of the wheelchair in normal use for a user suffering a symmetrical lower extremity weight loss relative to their midsagittal plane.

6. A stabilised wheelchair according to claim 5 wherein the weight device is located centrally relative to the left and right side of the wheelchair.

7. A stabilised wheelchair according to any one of claims 1-4 wherein the weight of the stabiliser assembly is asymmetrically distributed in the lateral direction relative to the midline of the wheelchair to maintain lateral stability of the wheelchair in normal use for a user suffering an asymmetrical lower extremity weight loss relative to their midsagittal plane.

8. A stabilised wheelchair according to claim 7 wherein the weight device is positioned in an offset location toward either the left or right side of the wheelchair.

9. A stabilised wheelchair according to claim 7 wherein the stabiliser assembly comprises a left-side weight device located toward the left side of the wheelchair and a right-side weight device located toward the right side of the wheelchair, and where the weights of each weight device differ to provide an offset weight distribution relative to the midline of the wheelchair.

10. A stabilised wheelchair according to any one of the preceding claims wherein the mounting assembly is configured to releasably secure the weight device directly to a footrest assembly of the wheelchair.

11. A stabilised wheelchair according to any one of claims 1-9 wherein the mounting assembly is configured to releasably secure the weight device to a part of a frame of the wheelchair.

12. A stabilised wheelchair according to claim 11 wherein the mounting assembly comprises a support frame that is releasably mounted to the wheelchair frame and the weight device is fixed directly to the support frame.

13. A stabilised wheelchair according to claim 11 wherein the mounting assembly comprises a support frame that is releasably mounted to the wheelchair frame and the weight device is releasably secured to the support frame via an operable coupling assembly.

14. A stabilised wheelchair according to claim 13 wherein the coupling assembly comprises a platform that is fixed to the support frame and which is arranged to support an underside of the weight device and wherein the weight device is releasably securable to the platform via an operable locking mechanism.

15. A stabilised wheelchair according to claim 14 wherein the operable locking mechanism comprises an operable locking pin provided on the weight device that is releasably engageable with a complimentary locking aperture provided on the platform.

16. A stabilised wheelchair according to claim 14 wherein the operable locking mechanism comprises an operable locking pin provided on the platform that is releasably engageable with a complimentary locking aperture provided on the weight device.

17. A stabilised wheelchair according to any one of claims 12-16 wherein the frame of the wheelchair comprises left and right support struts to which a footrest assembly is releasably mountable and the support frame of the mounting assembly of the stabiliser assembly is releasably secured to the left and right support struts in place of the footrest assembly.

18. A stabilised wheelchair according to claim 17 wherein the support frame of the mounting assembly comprises: a substantially U-shaped vertical support frame comprising two spaced-apart left and right substantially upright members being coupled together at their bottom ends by a cross member, and a substantially U-shaped horizontal sub-frame extends from the cross-member of the vertical support frame at an angle that is substantially perpendicular to the orientation of the left and right upright members of the vertical support frame.

19. A stabilised wheelchair according to claim 18 wherein the top ends of the upright members of the vertical support frame are configured for releasably securing with or into complimentary coupling systems or receiving apertures provided on the left and right support struts of the wheelchair frame.

20. A stabilised wheelchair according to any one of the preceding claims wherein the weight device of the stabiliser assembly comprises a housing that is configured to receive and retain one or more weight components.

21. A stabiliser wheelchair according to claim 20 wherein the housing of the weight device comprises top and bottom opposed plates between which one or more weight components in the form of weight plates are stacked, and the top and bottom plates of the housing and weight plates are secured together via one or more fixing components.

22. A stabilised wheelchair according to any one of claims 1-19 wherein the weight device is in the form of a heavy footrest assembly, the weight of the footrest assembly being sufficient to counterbalance the user's lower extremity weight loss to maintain fore-aft stability of the wheelchair in use.

23. A stabilised wheelchair according to claim 22 wherein the heavy footrest assembly comprises solid framing that is formed from a heavy material.

24. A stabilised wheelchair according to claim 22 wherein the heavy footrest assembly comprises a hollow framing that is ballasted with a ballast material.

25. A stabilised wheelchair according to any one of the preceding claims wherein the weight of the weight device is selected based at least partly on the weight of the lower extremity weight loss and the position of the weight device relative to the fulcrum balance point.

26. A stabilised wheelchair according to any one of the preceding claims wherein the frame of the wheelchair is fixed or collapsible.

27. A stabiliser assembly configured for installation on a wheelchair for use by a user suffering lower extremity weight loss, the wheelchair at least having a pair of rear propulsion wheels, the stabiliser assembly comprising:
a weight device or devices; and
a mounting assembly for releasably securing the weight device(s) to the wheelchair at a position forward of the rotation axis of the rear propulsion wheels of the wheelchair, and wherein the weight of the weight device(s) is sufficient to counterbalance the user's lower extremity weight loss to maintain fore-aft stability of the wheelchair in use.

28. A stabiliser assembly according to claim 27 wherein the weight device(s) have a fixed weight.

29. A stabiliser assembly according to claim 27 wherein the weight device(s) have an adjustable weight.

30. A stabiliser assembly according to any one of claims 27-29 wherein the mounting assembly is configured to secure the weight device(s) at a position forward of the fulcrum balance point of the wheelchair.

31. A stabiliser assembly according to any one of claims 27-30 wherein the weight of the stabiliser assembly in use is configured to be symmetrically distributed in the lateral direction relative to the midline of the wheelchair to maintain lateral stability of the wheelchair in normal use for a user suffering a symmetrical lower extremity weight loss relative to their midsagittal plane.

32. A stabiliser assembly according to claim 31 wherein the stabiliser assembly is configured such that the weight device(s) are located centrally relative to the left and right side of the wheelchair in use.

33. A stabiliser assembly according to any one of claims 27-30 wherein the weight of the stabiliser assembly in use is configured to be asymmetrically distributed in the lateral direction relative to the midline of the wheelchair to maintain lateral stability of the wheelchair in normal use for a user suffering an asymmetrical lower extremity weight loss relative to their midsagittal plane.

34. A stabiliser assembly according to claim 33 wherein the stabiliser assembly is configured such that the weight device(s) are positioned in an offset location toward either the left or right side of the wheelchair.

35. A stabiliser assembly according to claim 33 wherein the stabiliser assembly comprises a left-side weight device and a right-side weight device, and the stabiliser assembly is configured such that the left-side weight device is located toward the left side of the wheelchair and the right-side weight device is located toward the right side of the wheelchair, and where the weights of each weight device differ to provide an offset weight distribution relative to the midline of the wheelchair in use.

36. A stabiliser assembly according to any one claims 27-35 wherein the mounting assembly is configured to releasably secure the weight device(s) directly to a footrest assembly of the wheelchair in use.

37. A stabiliser assembly according to any one of claims 27-35 wherein the mounting assembly is configured to releasably secure the weight device(s) to a part of a frame of the wheelchair in use.

38. A stabiliser assembly according to claim 37 wherein the mounting assembly comprises a support frame that is releasably mountable to the wheelchair frame and the weight device(s) are fixed directly to the support frame.

39. A stabiliser assembly according to claim 37 wherein the mounting assembly comprises a support frame that is releasably mountable to the wheelchair frame and the weight device(s) are releasably secured to the support frame via an operable coupling assembly.

40. A stabiliser assembly according to claim 39 wherein the coupling assembly comprises a platform that is fixed to the support frame and which is arranged to support an underside of the weight device(s) and wherein the weight device(s) are releasably securable to the platform via an operable locking mechanism(s).

41. A stabiliser assembly according to claim 40 wherein each operable locking mechanism comprises an operable locking pin provided on the weight device that is releasably engageable with a complimentary locking aperture provided on the platform.

42. A stabiliser assembly according to claim 40 wherein each operable locking mechanism comprises an operable locking pin provided on the platform that is releasably engageable with a complimentary locking aperture provided on the weight device.

43. A stabiliser assembly according to any one of claims 38-42 wherein the frame of the wheelchair comprises left and right support struts to which a footrest assembly is releasably mountable and the support frame of the mounting assembly of the stabiliser assembly is configured to be releasably securable to the left and right support struts in place of the footrest assembly in use.

44. A stabiliser assembly according to claim 43 wherein the support frame of the mounting assembly comprises: a substantially U-shaped vertical support frame comprising two spaced-apart left and right substantially upright members being coupled together at their bottom ends by a cross member, and a substantially U-shaped horizontal sub-frame extends from the cross-member of the vertical support frame at an angle that is substantially perpendicular to the orientation of the left and right upright members of the vertical support frame.

45. A stabiliser assembly according to claim 44 wherein the top ends of the upright members of the vertical support frame are configured for releasably securing with or into complimentary coupling systems or receiving apertures provided on the left and right support struts of the wheelchair frame in use.

46. A stabiliser assembly according to any one of claims 27-45 wherein the weight device(s) of the stabiliser assembly comprise a housing that is configured to receive and retain one or more weight components.

47. A stabiliser assembly according to claim 46 wherein the housing of the weight device(s) comprises top and bottom opposed plates between which one or more weight components in the form of weight plates are stacked, and the top and bottom plates of the housing and weight plates are secured together via one or more fixing components.

48. A stabiliser assembly according to any one of claims 27-45 wherein the weight device is in the form of a heavy footrest assembly, the weight of the footrest assembly being sufficient to counterbalance the user's lower extremity weight loss to maintain fore-aft stability of the wheelchair in use.

49. A stabiliser assembly according to claim 48 wherein the heavy footrest assembly comprises solid framing that is formed from a heavy material.

50. A stabiliser assembly according to claim 48 wherein the heavy footrest assembly comprises a hollow framing that is ballasted with a ballast material.

51. A stabiliser assembly according to any one of claims 27-50 wherein the weight of the weight device(s) is selected based at least partly on the weight of the lower extremity weight loss and the position of the weight device relative to the fulcrum balance point.

52. A method of stabilising a wheelchair for a user suffering a lower extremity weight loss, the wheelchair comprising a frame that supports a seat and which is moveable over the ground surface by a set of manually operable rear propulsion wheels and one or more forward steering wheels, comprising:
determining a counterbalance weight for a weight device to be mounted at a position forward of the rotation axis of the rear propulsion wheels of the wheelchair that will be sufficient to counterbalance the user's lower extremity weight loss to maintain fore-aft stability of the wheelchair in use; and
mounting a weight device or devices having the determined counterbalance weight to the wheelchair at a position forward of the rotation axis of the rear propulsion wheels of the wheelchair.

53. A method according to claim 52 wherein the step of determining the counterbalance weight comprises selecting the weight based at least partly on the weight of the lower extremity weight loss and the intended position of the weight device relative to the rotation axis of the rear propulsion wheels.
